(19) United States
(12) Patent Application Publication
(10) Pub. No.: US 2023/0289652 A1
(43) Pub. Date: Sep. 14, 2023

(54) SELF-LEARNING AUDIO MONITORING SYSTEM

(71) Applicant: Matthias THÖMEL, Hannover (DE)

(72) Inventor: Matthias THÖMEL, Hannover (DE)

(21) Appl. No.: 17/694,147

(22) Filed: Mar. 14, 2022

(51) Int. Cl. G06N 20/00; H04R 1/08; G06F 3/0481; G06F 3/16

(52) U.S. Cl. CPC G06N 20/00; H04R 1/08; G06F 3/0481; G06F 3/16

(57) ABSTRACT

The methods and systems for facilitating the system learn and implement audio dependent user actions. The method includes detecting a first audio input generated by a machine using a microphone and determining features of the audio. The features of the audio input are searched in a feature database to determine one or more actions to be performed on the machine at the time the first audio is detected. In case the features are not found in the database, the method includes detecting a first user input and creating an association information based on the user input at the time of first audio detection. The method also includes saving the association information in the feature database to enable the system to automatically perform the associated actions upon detecting the audio input. The method is performed by one or more microprocessors.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present disclosure relates to audio monitoring systems, more particularly the disclosure relates to self-learning audio monitoring systems.

### 2. Description of Related Art Including Information Disclosed Under 37 CFR 1.97 and 37 CFR 1.98

As the technology advances, people have started using a variety of machines, instruments and devices to make their life easier. The devices they use in their daily life most of the time are provided with some controlling mechanisms using which people control the machines as per their needs. There are several types of machines/devices that produce different types of sounds and people operate them based on the type of sound produced by these machines. The sound produced can be a normal operating sound or sometimes can also indicate some warning or an emergency situation. People operate the machines by identifying the type of sound and accordingly control the machine using the controlling mechanism provided therewith.

The machines such as an engine of any vehicle, a musical system and other home appliances generate sounds/noises while they are being used. All of the discussed machines/appliances have some sort of controlling mechanism such as a set of buttons, keypads or touch interactive interfaces through which the user operates or controls the working of the machine. Some machines come with automatic shut-off mechanism to shut off the machine in emergency situation. In certain situation, an emergency light and/or a siren are activated to depict an adverse situation. The mechanics of the vehicle also listen to the type of sound generated by the vehicle's engine in order to identify the problem based on which the further repairing work is carried out. A sudden uncommon sound when produced by any home appliances like refrigerator is considered as a cause of some problem and the user accordingly turns the appliance off.

However, all of the machines/appliances/devices referred above make the daily life of the human being easier but they always require user's proper attention and physical interaction with the machine in order to operate the same. Therefore, there is need in the art to provide a system that automatically operates the machine without constant physical interaction of the user with the machine.

### BRIEF SUMMARY OF THE INVENTION

The present disclosure relates generally to audio monitoring systems, more particularly the disclosure relates to self-learning audio monitoring systems.

According to an aspect of the present disclosure a method includes detecting a first audio input, produced by a machine, using a microphone. The detected first audio input is searched in a feature database. Upon successfully finding the first audio input in the feature database the system performs one or more user's action, saved within the database in an encoded form, corresponding to the first audio input during a time the first audio is detected or generated. In case the first audio input is not found in the feature database, the system records the first audio input generated by the machine and simultaneously detects a first user input at the time of first audio input generation or detection. An association information is created based on the first user input received during the time the first audio is detected. The association information is saved in the feature database, wherein the one or more actions are performed based on the first user input saved in the feature database corresponding to the detection of the first audio.

In an embodiment, the one or more user inputs are converted to digital signal using an A2D converter for further processing including encoding (that represents one or more action steps), before saving in the database. Also, one or more audio inputs are pre-processed using techniques like filtering and pre-amplifying, followed by one or more feature extraction processing before being saved in the feature database. The system on detecting the audio input matching with one of the saved audio inputs converts the corresponding action inputs to analog signal using a D2A converter so as to automatically perform the action step on the machine without any user's intervention.

According to another aspect of the present disclosure, the system includes one or more processors and/or controllers configured to receive audio input(s) and user input(s) respectively generated by the machine and inputted by the user operating the machine. The system further converts the user input to a digital signal and saves the same in the feature database after encoding, along with the audio input at the time of user input. The system also processes the audio input using one or more pre-processing and feature extraction techniques prior to storing in the database. Further, the system makes sure that time of first audio input being saved in the feature database is in synchronization with the time of the first user input.

According to yet another aspect of the present disclosure, a computer program product, includes: a non-transitory computer readable storage medium comprising computer readable program code embodied in the medium that is executable by one or more processors of a computing device to perform the disclosed methods within the system.

An objective of the present disclosure is to enable the machines learn human actions by their own in real-time while being controlled by the humans and simultaneously perform the operations automatically based on the learnt actions as per varying situations in order to reduce the human-machine interactions for same task required again and again.

Another objective of the present disclosure is to develop a network and location independent system that makes any machine, particularly which is controlled based on sound/noise generated, intelligent.

Various objects, features, aspects and advantages of the inventive subject matter will become more apparent from the following detailed description of preferred embodiments, along with the accompanying drawing figures in which like numerals represent like components.

### BRIEF DESCRIPTION OF THE SEVERAL VIEWS OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a block diagram of the proposed system, in accordance with at least one embodiment.

FIG. 2 illustrates a schematic view of an exemplary embodiment of the proposed system including an industrial machine.

FIG. 3 illustrates a schematic view of an exemplary embodiment of the proposed system including a vehicle's engine.

FIG. 4 illustrates a schematic view of an exemplary embodiment of the proposed system including a musical stage light system.

FIG. 5 is a schematic view of a flow diagram illustrating a method for implementation of the proposed system in accordance with an embodiment of the present disclosure.

### DETAILED DESCRIPTION OF THE INVENTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

While embodiments of the present invention have been illustrated and described, it will be clear that the invention is not limited to these embodiments only. Numerous modifications, changes, variations, substitutions, and equivalents will be apparent to those skilled in the art, without departing from the scope of the invention, as described in the claim.

The present disclosure relates generally to a self-learning audio monitoring system, more particularly the present disclosure provides methods, systems and computer program products that provides self-learning audio monitoring system for automating a machine generally controlled by the humans based on different types of sounds produced by a machine.

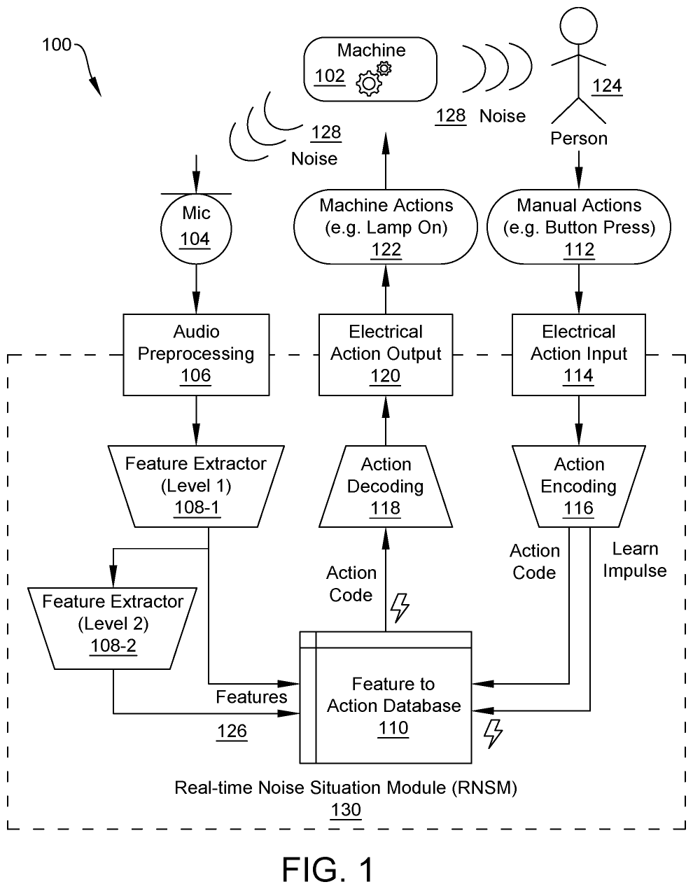

FIG. 1 illustrates a block diagram of the self-learning audio monitoring system, which facilitates automatic operation of a machine based on the learnt operations from the user actions, in accordance with an embodiment of the present disclosure.

In an aspect, the self-learning audio monitoring system 100 comprises of a Real-time Noise Situation Module (RNSM) 130. The monitoring system is coupled to a machine 102 through a wired or wireless connection. In an embodiment, the wired or wireless connection can be implemented as one of the different types of networks, such as intranet, local area network (LAN), wide area network (WAN), the internet, Wi-Fi, LTE network, CDMA network, and the like. Further, the wired or wireless connection can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the wired or wireless connection can be implemented by using a variety of network devices, including routers, bridges, servers, computing devices, storage devices, and the like.

RNSM 130 is implemented using one or more processors. The one or more processor(s) may be implemented as one or more microprocessors, microcomputers, microcontrollers, digital signal processors, central processing units, logic circuitries, and/or any devices that manipulate data based on operational instructions. Among other capabilities, the one or more processor(s) are configured to fetch and execute computer-readable instructions stored in a memory (not shown) of the system 100. The memory may store one or more computer-readable instructions or routines, which may be fetched and executed to create or share the data units over a network service. The memory may comprise any non-transitory storage device including, for example, volatile memory such as RAM, or non-volatile memory such as EPROM, flash memory, and the like.

Further, the RNSM 130 may receive inputs from the machine 102 and/or a user 124. The input received may be stored in the memory for further processing.

The system 100 comprises a microphone 104 which is connected to the processor integrated within the RNSM 130 in order to capture the sounds or noises 128 generated by the machine 102. The noise of sounds 128 may be produced as a result of operation of the machine 102. The microphone 104 is a transducer that converts the sound energy to a digital signal. The microphone 104 comprises of a diaphragm, a magnet and a coil suspended in the magnetic field, wherein the diaphragm receives and converts the air pressure caused due to the sound waves 128 to a mechanical motion, which further vibrates the coil suspended in the magnetic field, thereby converting the mechanical motion to an electrical or digital signal. Whenever the machine produces any sound 128, the microphone records the sound 128 and converts the sound to a digital audio signal which is transferred to the audio pre-processing module 106. In an embodiment, the sound 128 being detected initially for first time is referred to as a first audio input 128.

The audio input 128 is processed in order to extract useful information regarding uniqueness of the audio input 128. The processing of the audio input 128 includes audio pre-processing 106 and feature extraction using multiple feature extractors 108-1, 108-2 . . . 108-N (which are collectively referred to as feature extractors 108 and individually referred to as feature extractor N 108-N, hereinafter). The audio pre-processing 106 basically involves filtering and pre-amplifying the audio input 128 using various conventional techniques. Audio pre-processing 106 may include filtering and amplifying. Filtering may include passing or attenuating a particular frequency range from the audio input using a variety of filters based on the requirements. The different filters available are low-pass, high-pass, bandpass and all-pass filter. All of the filtering techniques are programmed within the processor and are automatically applied based on the audio input 128. Filtering basically cleans the unwanted noise from the audio input 128.

Afterwards, the processor pre-amplifies the filtered audio input 128 using pre-amplification algorithms. Pre-amplification generally converts a weak signal into a strong signal based on numerous factors including signal-to-noise ratio, range of input signal, response time, power consumption, dynamic range and few more. Thereafter, the processor extracts features 126 from the pre-processed audio using one or more computer implemented feature extractors 108. In an embodiment, the features 126 may depict various operational conditions or operational phases of the machine.

Feature extraction is one of the important techniques used in artificial intelligence, machine learning and pattern recognition. Feature extraction is a dimensionality reduction technique using which the large datasets are transformed to a reduced set of features, also referred as feature vectors, without losing any relevant information from the input data. The processor extracts the relevant features 126 from the pre-processed audio input 128 in a manner to uniquely identify the audio input 128 from other similar audio inputs 128 (e.g., second audio input, third audio input, . . . Nth audio input, each corresponding to different sounds produced by the machine 102 in different scenarios) and stores the same in the feature database 110.

In an embodiment, the feature extractors 108 may be implemented in various levels (level 1 108-1, level 2 108-2). The feature extractor level 1 108-1 may extract high level features of the first audio 128 and the feature extractor level 2 108-2 may extract low level features from the high level features of the pre-processed first audio 128. The high level features are abstract features in a format easily recognizable by humans as well as machines/computers and may depict the high level operational condition or phase of the machine. The high level features may include but not limited to rhythm, pitch and beat related information. In an embodiment, an output device including a display screen may display the features which may be read or visualized easily (by both humans and machines) in order to have some general information regarding the audio 128. In an embodiment, the display may depict the various machines being monitored which may be actively operational at a particular time. In an embodiment, the display may also depict an operational status of each machine. The operational status of the machine may depict if a particular machine is working normally or abnormally.

The low level features are statistical features extracted further from the high level features including but not limited to amplitude, energy, zero-crossing rate and spectral centroid, etc. Such features may be used further classify or recognize the audio with precision. Therefore, the system 100 initially extracts the high level features and uses the same for matching with the existing features 126 saved in the database 110, while extracts the low level features in case no match in found and again matches the low level features with the features 126 pre-saved in the database to determine the existence of the detected audio 128 in the feature database 110.

The feature database 110 is configured to store a set of features 126 corresponding to a unique audio input 128 generated by a machine 102 at a particular time. In an embodiment, the feature database 110 may include a reference number to reference a set of features to a particular audio input 128. The feature database 110 may also store an action code corresponding to each feature set 126 saved within the database 110. In an embodiment, the database may also include a unique machine ID corresponding to the action code and the corresponding feature set 126. The unique machine ID may be used to recognize a particular machine from a plurality of machines on which an action corresponding to the action code needs to be performed. The action code may represent a user input 114 in an encoded form. The user input 114 may be detected by the processor at the time of audio input 128 was detected and captured in Learning mode (described later). Whenever the RNSM 130 detects an audio input via the microphone 104, the processor upon feature 126 generation of the audio input 128, searches the entire feature database 110 for a match of feature or feature set 126 in the feature database 110. In case the currently determined feature or feature set 126 matches with any of the feature or feature set 126 saved in the database 110, the processor determines a machine ID and executes the action code stored corresponding to the matched feature 126. Thereby the action 122 corresponding to the detected and saved feature 126 is automatically performed on the machine based on the detection of a particular sound made by the machine during operation. The mode in which automatic execution of the action corresponding to the detected and saved feature 126 in the feature to action database 110 is performed is referred as “Replay Mode”.

Furthermore, in case the currently detected feature 126 does not matches with any of the features 126 saved in the feature to action database 110 then the processor determines the sound 128 being produced by the machine 102 as a new sound input. Moreover, the machine 102 is provided with a user interface 112 so as to detect a user input 114 in order to accordingly operate or control the machine 102. The user interface 112 may be a machine control panel comprising plurality of buttons, keypads or a touch sensitive screen using which the user 124 controls the machine 102. The user 124 of the machine 102 upon listening to the audio 128 generated by the machine 102 may give input 114 using the user interface 112 to control the operations of the machine 102. The user input 114 is an electrical action input 114 that includes one or more action steps e.g., pressing buttons, to perform one or more actions 122 e.g., controlling the machine, based on the audio 128 generated by the machine 102.

The processor upon determining the first audio input 128 as a new sound i.e., the feature 126 of which is not saved in the database 110, detects a first user input 114 simultaneously at the time of detection of the first audio 128 determined if there is an input detected from user 124 through a user interface 112. In an embodiment, the user interface 112 may be manual action buttons or a touch enabled interface. Subsequent to the detection of the user input from user 124 at the time of detection of the first audio 128, association information is created and saved in the feature database 110. The association information may act as a map between the first user input 114 with the features detected first audio input 128 and the machine. The user input 114 is mapped or associated to the feature set of the audio input 128 and the machine ID in a “Learning Mode” to create association information. The first user input 114 includes one or more actions performed by the user 124 using the user interface 112 at the time of first audio 128 generation which is saved as an encoded user action code in the association information. In an embodiment, when the RNSM 130 determines that the features of the first audio are not saved in the feature database the RNSM 130 may output an indication on the user interface 112 including a display or an alarm, to depict that no association information is determined corresponding to the detected audio input and to prompt a user to input a user input through the user interface 112.

The user input 114 generally is an analog signal that needs to be converted to a digital signal prior to saving in the database 110. An analog-to-digital (A2D) converter is connected to the processor that receives the user input 114 by means of the user interface 112 and converts the same to a digital signal. A2D converter follows a sequence during the conversion i.e., the converter samples the analog signal of user input 114, thereafter quantifies the same for resolution determination and lastly sets binary values representing the digital signal for the analog user input 114 being converted. One or more user inputs 114 are converted to digital signal and are encoded using an action encoding method 116 before being mapped and saved in the feature database 110.

Action encoding 116 translates all the digital signals corresponding to one or more actions of user input as electrical action input 114 to an internal action code for storing purpose, which in future might easily be decoded back for automatic machine action 122 executions at the time of same audio input 128 generation by the machine 102 as saved in the database 110. Whenever the machine 102 produces the audio input 128 as saved in the feature database 110, the processor configured in the RNSM 130 searches the feature 126 of the audio input 128 and decodes the corresponding action code associated with the audio input 128 back to the digital signal using an action decoding method 118. Action decoding 118 translates the saved action code to the digital signal. In an embodiment, the digital signal may correspond to a digital command transmitted to the machine directly based on one or more communication interface (not shown) between the machine 102 and the RNSM 130. In another embodiment, the digital signal is further converted to analog action output 120 based on which the machine performs the intended machine actions 122. The digital signal is converted to analog signal using a digital-to-analog (D2A) converter, resulting in automatic execution of the associated action 122 without any physical user interaction.

The D2A converter converts the digital signal obtained from action decoding 118 back to the original analog form representing the same user input 114 as input by the user 124 during the audio input 128 using the user interface 112. The D2A converter basically takes the binary numbers of the digital form of signal and converts the same into an analog voltage or current. The analog signal or the digital signal may be used to operate the machine 102 to act exactly in the same manner as the user 124 might have operated the machine 102 from the user interface 112.

In an embodiment, the machine 102 generally comprises of, but not limited to, an industrial machine 102-1, a vehicle's engine 102-2, a musical stage lighting system 102-3 or any other machine that is controlled based on the audio 128 generated by the machine 102. Further, the user 124 of the machine 102 is the person operating the machine including such operator, driver or any person responsible for controlling or using the machine 102.

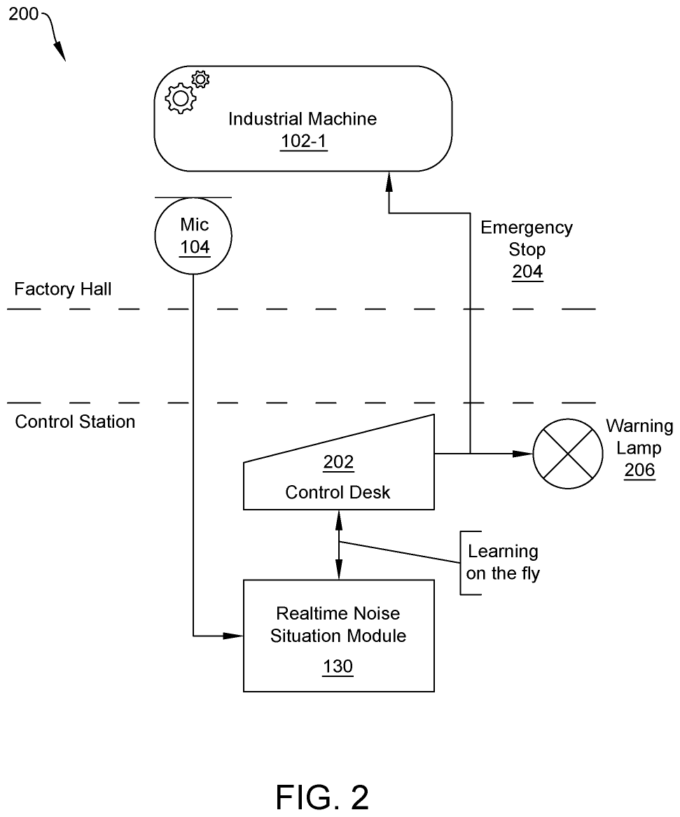

FIG. 2 illustrates an exemplary embodiment of the proposed system 100 including an industrial machine 102-1.

In an embodiment, the machine 102 is an industrial machine 102-1 to which the RNSM 130 is configured with. The industrial machine 102-1 generates different types of noises during the operation based on which the operator controls the machine 102-1 using the control desk 202 having some kind of user interface 112 to perform the manual actions. The RNSM 130 continuously monitors the type of noise produced by the machine 102-1 and either maps the same to the operator's action performed at the time of the noise generation, in “Learning Mode”, or automatically performs the actions saved in the feature database corresponding to previously saved noises, in “Replay Mode”. For example, the user 124 of the machine 102-1 may turn on a warning lamp 206 and/or activate an emergency stop 204 associated with the machine 102-1 upon listening a specific sound generated by the machine 102-1. The system 200 learns the same by mapping the sound features to the user's manual action and automatically performs the action in case of determining the same sound in future.

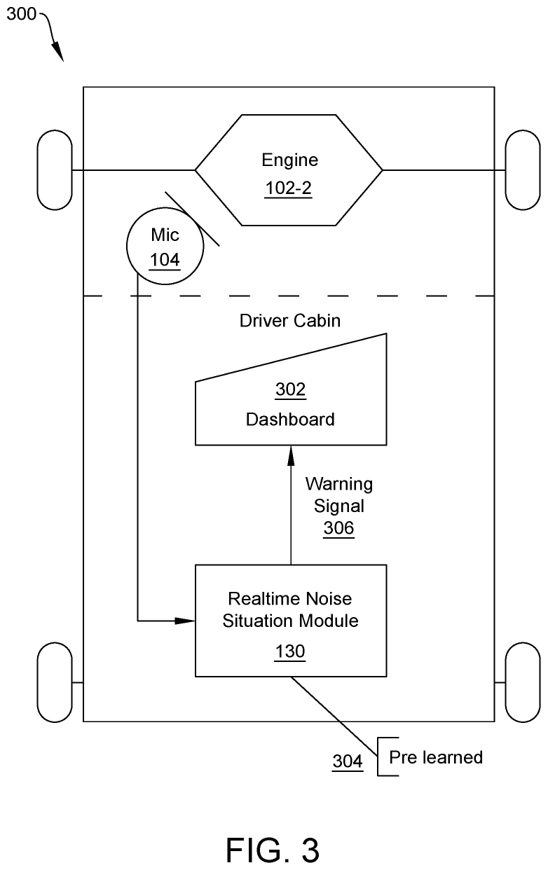

FIG. 3 illustrates an exemplary embodiment of the proposed system 100 including a vehicle's engine 102-2.

In an exemplary embodiment, the machine 102 is a car's engine 102-2 in which the RNSM 130 is configured and coupled. The RNSM 130 comprises a pre-learnt 304 set of noise situations provided by the car's manufacturers. The pre-learnt database 304 is having a variety of sounds produced by the car's engine 102-2 in different situations including but not limited to malfunctioning, low water level in radiator, and damaged components. Every time the car's engine 102-2 makes any of the sounds as saved in the pre-learnt database 304, the RNSM 130 triggers a warning signal 306 to display a message on the dashboard 302 to alert the driver of the car. Alternatively, the RNSM 130 also logs the situation to an internal logbook that further helps a mechanic properly understand the problem in the car's engine 102-2.

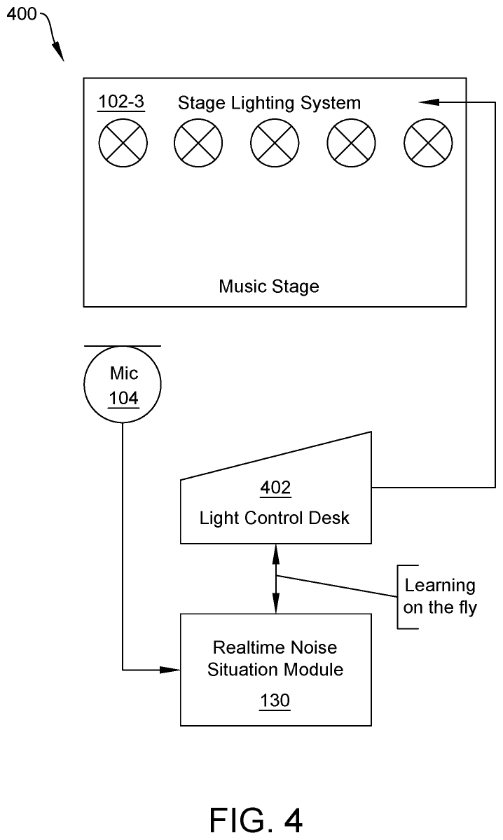

FIG. 4 illustrates an exemplary embodiment of the proposed system 100 including a musical stage light system 102-3.

In an embodiment, the machine 102 is musical stage light system 102-3 in which the operator changes the light based on the music being played. The RNSM 130 connected with the music stage system 102-3 learns the light changing mechanism controlled by the operator using the light control desk 402 based on the music currently being played, and replays the same lightening effect whenever the same music is repeated in the future.

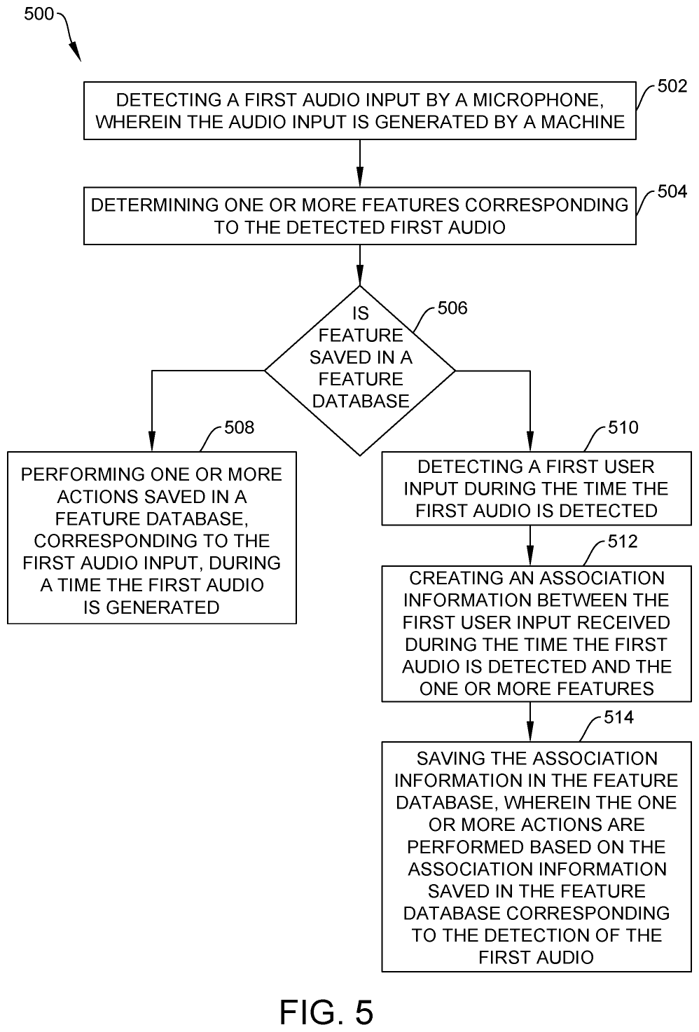

FIG. 5 is a flow diagram 500 illustrating a method for implementation of the proposed system 100 in accordance with an embodiment of the present disclosure.

In context of flow diagram 500, at block 502, a microphone 104 detects a first audio input 128 generated by a machine 102 so that at block 504 one or more features 126 corresponding to the detected first audio 128 may be determined or extracted using the feature extractors 108. Further, the system 100 checks whether the determined features 126 are saved in the feature database 110 or not, by means of matching the currently extracted features 126 with all of the existing features saved previously in the database 110, if any. The system 100 on finding a match at block 506 performs one or more actions at block 508 correspondingly saved in the database 110.

In case no match is found at block 506, the system 100 detects the first user input 114 at block 510 by means of the manual actions 112 at the time of first audio 128 generation by the machine 102 so as to create an association information at block 512 between the first user input 114 and the features 126 of first audio 128. Thereafter, the system 100 using the method 500 saves the association information in the feature database 110 at block 514 so that one or more action encoded in the association information might be performed automatically on detecting the first audio 128.

Embodiments of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

1. A self-learning audio monitoring system, comprising:
one or more processors configured to:
detect a first audio input by a microphone so as to determine a detected first audio, wherein the first audio input is generated by a machine;
determine one or more features corresponding to the detected first audio; and
perform one or more actions saved in a feature database in case the one or more features are saved in the feature database during a time the first audio is generated,
wherein, when one or more features are not saved in the feature database, the one or more processors are configured to:
detect a first user input during the time the first audio is detected;
create an association information between the first user input received during the time the first audio is detected and the one or more features; and
save the association information in the feature database, wherein the one or more actions are performed based on the association information saved in the feature database corresponding to the detection of the first audio.

2. The system, as claimed in claim 1, wherein the first user input is converted to a digital signal through an analog-to-digital (A2D) converter prior to being saved in the feature database.

3. The system, as claimed in claim 1, wherein the detected first audio is pre-processed to filter noise and pre-amplify the first audio.

4. The system, as claimed in claim 1, wherein the first user input comprises of one or more action steps.

5. The system, as claimed in claim 4, wherein the one or more action steps corresponding to the first user input are converted to analog signal using a Digital-to-Analog (D2A) converter.

6. The system, as claimed in claim 5, wherein the one or more action steps corresponding to the first user input are performed automatically on the machine.

7. The system, as claimed in claim 1, wherein the machine comprises an industrial machine, a vehicle's engine and a musical instrument.

8. The system, as claimed in claim 1, comprises further comprising: a user interface to detect the first user input.

9. A method for self-learning audio monitoring, comprising the steps of:
detecting a first audio input by a microphone so as to determine a detected first audio with one or more processors, wherein the audio input is generated by a machine;
determining one or more features corresponding to the detected first audio;
performing one or more actions saved in a feature database if the one or more features corresponding to the first audio input are saved in the feature database during a time the first audio is generated;
detecting a first user input during the time the first audio is detected when the one or more features corresponding to the first audio input are not saved in the feature database;
creating an association information between the first user input received during the time the first audio is detected and the one or more features when the one or more features corresponding to the first audio input are not saved in the feature database; and
saving the association information in the feature database, wherein the one or more actions are performed based on the association information saved in the feature database corresponding to the detection of the first audio.
